(19) United States
(12) Patent Application Publication
(10) Pub. No.: US 2026/0145367 A1
(43) Pub. Date: May 28, 2026

(54) FILM PROCESSING LINE FOR PRODUCING A PLASTIC FILM WEB AND METHOD FOR CLEANING COMPONENTS OF FILM PROCESSING LINES FOR PRODUCING A FILM WEB

(71) Applicant: Reifenhäuser GmbH & Co. KG Maschinenfabrik, Troisdorf (DE)

(72) Inventors: Anton RÜBHAUSEN, Niederkassel (DE); Andreas BÖHM, Wiehl (DE); Simon FROITZHEIM, Niederkassel (DE); Helmut MEYER, Troisdorf (DE); Mark SCHUSTER, Bonn (DE); Oliver THEILE, Engelskirchen (DE); Paul WALACH, Troisdorf (DE)

(21) Appl. No.: 19/120,342

(22) PCT Filed: Oct. 16, 2023
(86) PCT No.: PCT/EP2023/078641

§ 371 Date: Apr. 11, 2025

(30) Foreign Application Priority Data
Oct. 18, 2022 (DE) 10 2022 127 362.8

(51) Int. Cl. B29C 33/72; B29C 43/24; B29C 43/46

(52) U.S. Cl. CPC B29C 33/72; B29C 43/24; B29C 43/46

(57) ABSTRACT

A film processing line for producing a plastic film web, in particular a cast film, calendar or blown film line, including the following features:
a. the film processing line is provided with a machine direction along which the film web is transported via the film processing line, and
b. the film processing line is provided with a roller device that processes the film material, and
c. the roller device is provided with at least one film roller that is in contact with the film web,
characterised by the following further feature:
d. the film processing line is provided with a cleaning device, with which a surface of at least one film roller of the roller device in contact with the film web can be cleaned in an operating state.

### CROSS REFERENCE TO RELATED PATENT APPLICATIONS

This is a U.S. national phase patent application of PCT/EP 2023/078641 filed Oct. 16, 2023, which claims the benefit of and priority to German Patent Application No. 10 2022 127 362.8, filed on Oct. 18, 2022, the entire contents of each of which are incorporated herein by reference for all purposes.

### TECHNICAL FIELD

The invention relates to a film processing line for producing a plastic film web, in particular a cast film, calendar or blown film line, a cleaning device for a film processing line as well as a method for cleaning components of film processing lines for producing a film web, in particular a cast film, calendar or blown film line.

### BACKGROUND

In film processing lines, deposits from the plastic melt (“plate-out”) cause contamination on the roller surface, wherein the contamination is formed from condensates or other secretions of substances from the extrusion product. This has negative impacts on the film produced, for example differences in gloss or matt areas, spots or streaks as well as inclusions. As a result, the film quality falls and, in the worst case, the film becomes unusable. As of a particular degree of contamination, cleaning and/or polishing must be carried out accordingly.

It is known in the prior art that the roller(s) of the film processing line must be cleaned at regular intervals. Admittedly, complete cleaning is only possible when operation is stopped. This results, on the one hand, in a loss of production due to shutting down and starting up as well as a line stoppage and, on the other hand, personnel being required for the cleaning.

### SUMMARY

The object which forms the basis of the present invention is to provide an improvement or an alternative to the prior art. In particular, it is the object of the invention to make possible a cleaning solution without manual interventions and, if at all possible, during the operation of the film processing line.

According to a first aspect, the formulated object is achieved by a film processing line for producing a plastic film web, in particular a cast film, calendar or blown film line, comprising the following features: a machine direction along which the film web is transported via the film processing line, a roller device that processes or conducts the film material and at least one film roller that is in contact with the film web. Furthermore, the film processing line is provided with a cleaning device, with which a surface of at least one film roller of the roller device in contact with the film web can be cleaned in an operating state.

Conceptually, the following is explained:
It is expressly pointed out that within the framework of the present patent application, indefinite articles and indefinite numerals such as “one . . . ”, “two . . . ”, etc. are normally to be understood as indicating a minimum, that is to say, “at least one . . . ”, “at least two . . . ”, etc., unless it is clear from the context or the specific text of a particular passage that only “exactly one . . . ”, “exactly two . . . ”, etc. are intended. Furthermore, all numerals and all information on method parameters and/or apparatus parameters are to be understood in the technical sense, i.e., taking into account the usual tolerances. Even if the restrictive wordings “at least” or the like are explicitly indicated, this does not mean that if it simply says “one”, that is to say without the use of “at least” or the like, “exactly one” is intended.

In other words, the machine direction is in particular to be understood to be a direction along which a raw material is processed into a film web. Within the framework of the present invention, a roller device preferably refers to a mechanical arrangement of at least one film roller which, in turn, is configured to have a shaping effect on the film web. Furthermore, the roller device can have a corresponding electronic control apparatus and a drive such as, for example, a motor. Within the framework of the present invention, the term “operating state” can describe a state in which the film processing line produces the film web, that is to say is active. Put simply, the operating state is consequently in particular the state in which the film processing line runs, starts up, shuts down or in particular when a roll change is performed. Within the framework of the present invention, the cleaning device is in particular to be understood to be a system which is configured to remove contamination from the roller surface. In addition, the cleaning device can be configured to perform cleaning of the film roller at regular intervals or continuously.

In an embodiment of the first aspect of the invention, the cleaning device is in particular configured to at least partially remove a coating on the surface of the film roller that is in contact with the film web. Within the framework of the present invention, the term “remove” can preferably be understood to mean that contamination is removed from the film roller, for example by scraping, scratching, brushing, rubbing or comparable methods. Furthermore, the “removal” can also be performed as non-contact removal of the contamination from the film roller, for example by evaporation, burning or the like so that, in this case, there is no direct contact of an element of the cleaning device with the film roller. The film roller can have a wanted coating, the so-called working coating, or no working coating. The coating can accordingly also comprise the optional working coating of the film roller. In other words, the unwanted coating can also be understood to be a deposit build-up or a layer on the surface or on the optional working coating of the film roller.

The film processing line can have a measuring device which preferably comprises a camera, particularly preferably a line scan camera, and which is configured to measure a thickness of the coating on the surface of the film roller that is in contact with the film web. A line scan camera is in particular understood to be a type of camera which has only one light-sensitive line. Alternatively, the measuring device can comprise at least one lighting means such as, for example, a laser, and at least one sensor, wherein the sensor is configured to perform a light measurement. The film processing line can be configured to perform the cleaning of the surface of the film roller as a function of the measured thickness of the coating on the surface. To that end, the film processing line can, furthermore, have a control device and in particular, furthermore, a computing unit, wherein the computing unit can in addition be configured for an evaluation of the measured thickness of the coating on the surface.

For example, the cleaning device is in addition configured to deliver the coating at least partially to the film web. To that end, the coating can initially be collected or alternatively conducted directly in the direction of the film web. “Coating” is in particular to be understood to be the contamination located on the film roller and, optionally, as already mentioned above, additionally the working coating of the film roller. The working coating is preferably left on the film roller, while the contamination is removed and, if necessary, at least partially delivered to the film web.

It is conceivable that the cleaning device is provided with a cleaning element for non-contact removal of the coating. In particular, this means that no element of the cleaning device is in contact with the film roller.

It can be provided that the cleaning device is provided with a cleaning element for abrasive removal of the coating. Within the framework of the present invention, abrasive is in particular to be understood to mean that there exists a rubbing, grinding effect which leads to smoothing, cleaning or wear and tear. To that end, the cleaning apparatus can be arranged in the immediate vicinity of the film roller and preferably have the cleaning element which is in contact with the film roller at least at intervals of time or continuously in order to perform the abrasive removal of the coating on the film roller. To that end, the cleaning element can have, for example, at least one polishing element, a cloth or the like.

Furthermore, the cleaning element optionally comprises a laser which is configured to remove the coating. The laser is in particular to be understood to be a laser system which, furthermore, comprises at least one control system and a suction apparatus. The laser system can in addition have a beam expander, a mirror and a focusing lens. The laser ensures in particular that the coating evaporates, burns or melts, wherein in the latter case said coating can at least be partially fed back to the film web.

It is possible that the laser is configured as a pulse laser with a frequency in a range between 50 kHz and 300 kHz, preferably between 150 kHz and 200 kHz. In addition, the laser in particular has a power, wherein the power preferably lies between 2 W and 30 W. Alternatively, a more powerful laser can be provided, the power of which can lie between 30 W and 100 W. In a preferred embodiment, the laser can have a laser power of 6 W to 10 W. In a preferred embodiment, the laser can be configured to adjust the power of the laser in a regulation range between 10% and 100% of the power. To that end, the laser can have a corresponding regulation system. At a frequency of 50 kHz, the laser in a specific embodiment has a pulse energy of 1 mJ. The pulse energy is in particular directly proportional to the average power and inversely proportional to the repetition rate of the laser. Furthermore, the laser preferably has a wavelength in the range between 400 nm and 1200 nm, in particular between 1055 nm and 1070 nm. Alternatively, it is also conceivable that the laser is configured as a continuous laser, i.e., as a continuous-wave laser. Furthermore, the frequency and/or the number and strength of the power levels as well as the wavelength of the selected laser can also vary depending on the specific application in order to guarantee that the film roller is cleaned without destroying the same. Within the framework of the invention, a pulse laser is in particular understood to be a laser which does not emit the light continuously, but rather is operated in a pulsed manner, i.e., emits the light in time-limited portions. In particular, the wavelength of the laser describes the spatial frequency of the emitted light wave. The optimal wavelength for a particular application essentially depends on the respective application. Within the framework of the present invention, the power of the laser, i.e., the power level of the laser selected in each case, is in particular understood to be an optical output power of a continuous-wave (CW) laser or, respectively an average power of a pulse laser. A pulse laser has a specific pulse duration which is defined as the half-value width of the optical power of the laser over time. Within the framework of the present invention, the pulse duration is preferably between 100 ns and 140 ns. Thus, the laser can alternatively also be configured as an ultrashort pulse laser which has pulse durations in the order of magnitude of picoseconds to attoseconds. Within the framework of the present invention, the frequency is preferably understood to be the pulse repetition frequency of the pulse laser, which describes the number of pulses emitted per second or the reciprocal of the temporal pulse spacing. The light of the laser is preferably randomly polarised, so that emitted electric fields point in random directions. Alternatively, the light of the laser can also be linearly polarised, so that the emitted electric fields consistently point in the same direction. Furthermore, the laser has a particular beam diameter which in particular characterises the transverse extent of the beam or the physical size of the beam perpendicular to the direction of propagation. The beam diameter determines a power/energy density or an optical power/energy per unit area of a laser beam. The larger the beam diameter, the smaller the power/energy density of a beam having constant power or energy. Furthermore, the laser has a beam profile which describes the intensity distribution in a cross-section of the beam. Common beam profiles comprise, for example, Gaussian and flat-top beams, the beam profiles of which are Gaussian-shaped or, respectively rectangular. In addition, the laser has the property of divergence which describes a broadening of a beam with increasing distance in relation to a beam waist of the laser through diffraction and is defined via a half angle of the laser. A further characterising property of the laser is a spot size which describes a beam diameter at the focal point of a focusing lens system. In order to maximise the power density, the spot size should preferably be selected to be as small as possible. For example, instead of conventional spherical lenses, aspherical lenses can be used in order to reduce spherical aberrations and to generate smaller spot sizes. There is a so-called working distance between the laser, or respectively between the last optical element of the laser, and the object, for example the coating on the surface of the film roller.

In a further possible embodiment according to the first aspect of the invention, the cleaning element comprises a vapour applicator which is configured to remove the coating with a vapour. The vapour applicator is configured, for example, as an electric vapour generator which can provide the vapour at adjustable temperatures and at an adjustable pressure. To that end, the vapour applicator can, furthermore, have a corresponding control apparatus.

In addition, the vapour can be water vapour. Alternatively, the vapour can be a solvent from the group of aprotic solvents, protic solvents and indifferent solvents. The use of a solvent can facilitate the removal of the coating. An organic solvent such as acetone can, for example, be provided as the solvent, wherein the choice of solvent depends on the material of the film web.

In a further possibility, the cleaning element comprises a plasma emitter which is configured to remove the coating. The term plasma is used in particular to refer to a gas which consists partly or completely of free charge carriers, that is to say, ions or electrons. Said gas is accordingly preferably emitted with the plasma emitter onto the film roller in order to at least partially remove the coating.

It can additionally be provided that the cleaning device is provided with an applicator for cleaning agents for application to the surface and/or the coating on the surface of the at least one film roller in contact with the film web. Within the framework of the present invention, a solvent such as acetone, a polishing paste and/or water is, for example, provided as the cleaning agent. The applicator can, furthermore, have a control system in order to apply the cleaning agent at intervals of time or at particular times to the surface or the coating on the surface of the at least one film roller in contact with the film web. Alternatively, the applicator can apply the cleaning agent continuously to the surface or the coating on the surface of the at least one film roller in contact with the film web.

For example, the cleaning device is configured as a cleaning unit which has a housing, and the cleaning unit forms a mobile unit which can be moved for cleaning surfaces of a plurality of film rollers of the roller device in contact with the film web. To that end, the cleaning unit can have a rail and/or a mounting system as well as a control system in order to move the cleaning unit between the film rollers of the roller device in contact with the film web. Within the framework of the present invention, it is conceivable that the cleaning device or the cleaning unit has multiple cleaning elements which are arranged in each case on or in the vicinity of one of the plurality of film rollers of the roller device in contact with the film web in order to make possible simultaneous, alternating or randomly performed cleaning on the film rollers. It is also possible that multiple cleaning elements are provided for cleaning an individual film roller. The multiple cleaning elements can be the same type of cleaning elements, i.e., for example abrasive or non-contact, or a combination of various types of cleaning elements.

According to a second aspect of the invention, the formulated object is achieved by a cleaning device for the film processing line according to the invention.

According to a third aspect of the invention, the formulated object is achieved by a method for cleaning components of film processing lines for producing a film web, in particular a cast film, calendar or blown film line, comprising the following steps: providing a film processing line, providing a roller device that processes or conducts a film material which is provided with at least one film roller that is in contact with the film web as well as providing a cleaning device, with which a surface of at least one film roller of the roller device in contact with the film web can be cleaned in an operating state. Furthermore, cleaning of the at least one film roller of the roller device in contact with the film web is performed in an operating state by at least partially removing a coating on the at least one film roller. This is performed with the cleaning element which can be configured as an abrasive or as a non-contact cleaning element. An application time of the cleaning element can be varied for the cleaning. If provision is made for a laser to be used for the cleaning, the application time of the laser can be between 30 and 90 seconds, in particular between 50 and 70 seconds. Optionally, a partial or a complete recirculation of the removed coating is additionally performed. The removal can be performed up to the optional working coating of the at least one film roller, or the working coating can be partially or completely removed as well. Without the existence of a working coating, the removal can remove the coating in part or, in particular, completely.

In addition, it is possible that the cleaning is performed as a traversing movement or as all-over cleaning. In other words, the traversing movement is in particular to be understood to mean that the cleaning element only covers the surface of the film roller axially in part and the surface is accordingly cleaned by moving back and forth. In the case of the all-over cleaning, the cleaning element fully covers the entire axial width of the surface of the film roller and accordingly does not have to be moved in order to completely clean the surface of the film roller.

It is possible that the method furthermore comprises the step of providing a measuring device which preferably comprises a camera, particularly preferably a line scan camera, wherein the measuring device is configured to measure a thickness of the coating on the surface of the film roller in contact with the film web. Subsequently, a measurement of the coating on the film roller of the roller device that is in contact with the film web is preferably performed. Thereafter, the cleaning device can be controlled as a function of the measured thickness of the coating. The measuring device can comprise corresponding electronics and software which makes it possible to measure and evaluate the measurement. Within the framework of the present invention, the thickness of the coating is in particular to be understood to be a radial thickness in relation to the film roller.

In addition, it is conceivable that the measurement of the thickness of the coating is performed by emitting light onto the surface of the film roller and subsequently measuring a reflected proportion. Based on the measurement of the reflected proportion, a grey-scale value analysis can be performed in order to determine the thickness of the coating. Within the framework of the present invention, a grey-scale value is preferably understood to be the apparent brightness of an image or of an individual pixel, which is accordingly analysed within the framework of the grey-scale value analysis. The image to be analysed in relation to the grey-scale values can be provided in the previous step by a camera, in particular a line scan camera. For the grey-scale value analysis, the measuring device or the film processing line can have a computing unit which can be connected to the measuring device or the camera or the line scan camera. The grey-scale value analysis can be based on the fact that less light is reflected back from the surface of the film roller with a thicker coating on the surface of the film roller and, consequently, the reflected light is less bright.

Furthermore, the control system of the cleaning device can provide at least one regulation, a triggering and/or a shutdown of the cleaning. Regulation can be understood, for example, to mean increasing or decreasing a cleaning speed of the surface of the film roller. Triggering refers in particular to starting the cleaning of the surface of the film roller, which can, furthermore, comprise the cleaning device approaching the surface of the film roller. In other words, a shutdown preferably refers to stopping the cleaning of the surface of the film roller, which can, furthermore, comprise the cleaning device moving away from the surface of the film roller.

### DESCRIPTION OF DRAWINGS

The invention is explained in greater detail below based on exemplary embodiments with reference to the drawings, wherein:

FIG. 1 shows a schematic representation of the roller device with an abrasive cleaning element;

FIG. 2 shows a schematic representation of the roller device with a laser as the cleaning element;

FIG. 3 shows a schematic representation of the roller device with a vapour applicator as the cleaning element and a measuring device;

FIG. 4 shows a schematic representation of the roller device with a plasma emitter as the cleaning element;

FIG. 5 shows a schematic representation of the roller device with a laser as the cleaning element as well as additionally with an applicator.

### DESCRIPTION OF AN EMBODIMENT

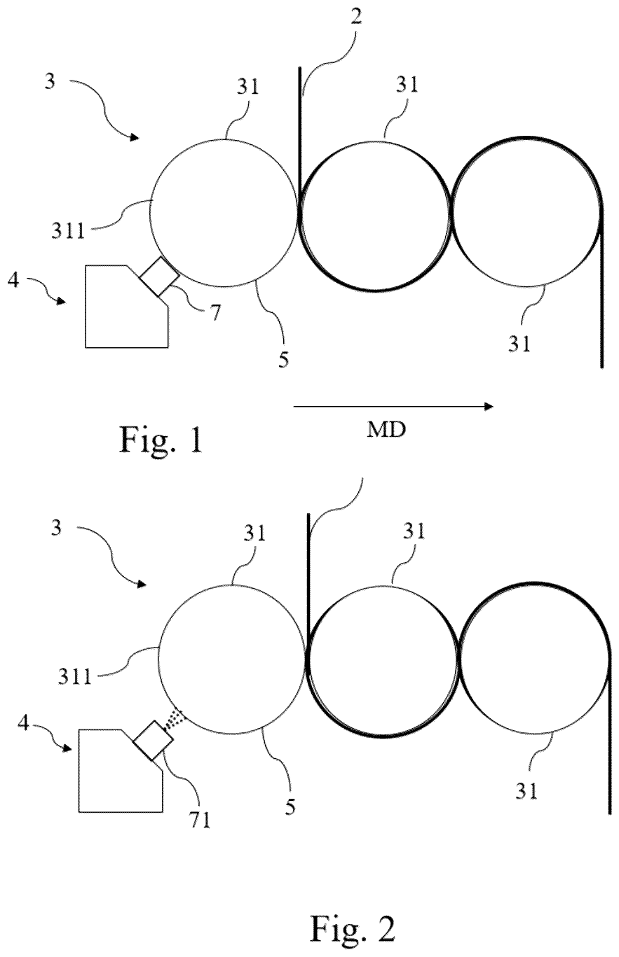

FIG. 1 shows a schematic representation of a roller device 3 according to the invention, which is part of a film processing line 1 (not depicted) and which, in this exemplary embodiment, has three film rollers 31. The film rollers 31 in turn have a surface 311 on which a coating 5 accumulates during the operation of the film processing line 1. The film web 2 is shaped between the film rollers 31. Furthermore, the machine direction MD is depicted, which represents that direction in the film processing line 1 from a raw material to a completed film web. Here, by way of example, a cleaning device 4 is, furthermore, arranged on the first film roller 31. It is also conceivable, within the framework of the invention, that the cleaning device 4 is arranged on the second or third or, in each case, on all of the film rollers 31 provided. Furthermore, the cleaning device 4 comprises a cleaning element 7 which is configured in this embodiment as an abrasive cleaning element 7.

FIG. 2 differs from the arrangement in FIG. 1 only in that the cleaning element 7 is, in this case, configured as a laser 71 and, consequently, as a non-contact cleaning element 7. The laser beams which act on the coating 5 on the surface 311 of the film roller 31 are shown in dashed lines. The laser 71 is a pulsed laser with a frequency in a range between 150 kHz and 200 kHz. Furthermore, the laser 71 has two power levels, wherein the first power level lies between 10 W and 30 W and the second power level lies between 30 W and 100 W. In addition, the laser 71 has a wavelength in the range between 400 and 1200, in particular 1064 nm.

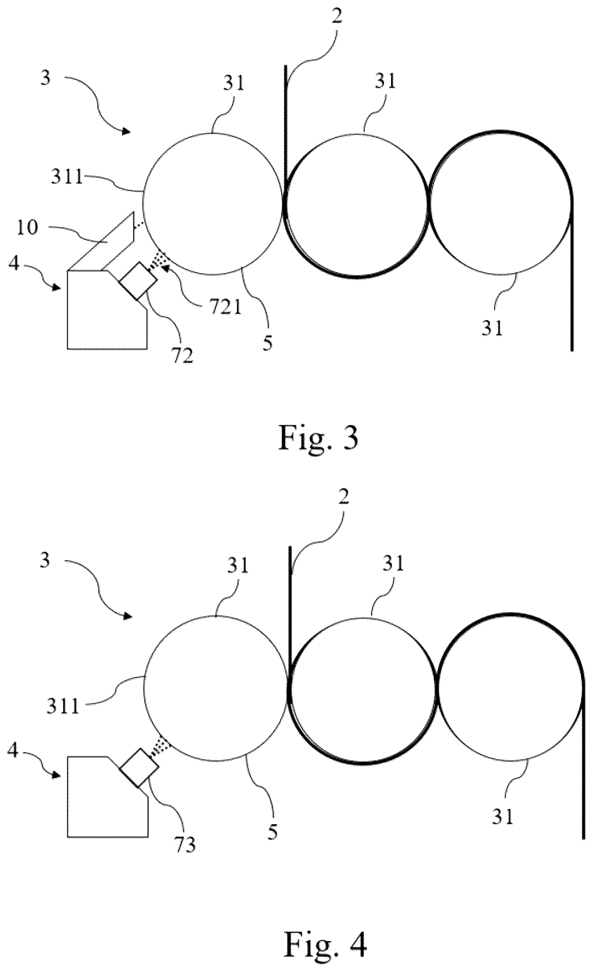

In contrast to FIGS. 1 and 2, FIG. 3 has a vapour applicator 72 as the cleaning element 7, which, depicted with dashed lines, applies a vapour 721 in the form of water vapour to the coating 5 on the surface 311 of the film roller 31. In this case, an application of a solvent would also be a conceivable alternative. In addition, in this embodiment, the film processing line 1 has a measuring device 10 which is arranged here, by way of example, on the cleaning device 4. The emission of light from the measuring device 10 is depicted here schematically in dashed lines, wherein the reflected proportion of the light is subsequently measured in order to extrapolate a thickness of the coating 5 with a grey-scale value analysis. However, the measuring device 10 can also be combined with the further embodiments described within the framework of the present invention in order to provide a measurement of the thickness of the coating 5.

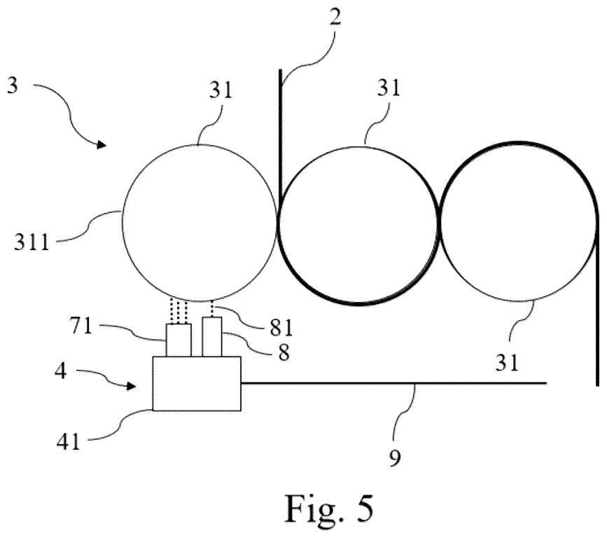

The arrangement of the roller device 3 from FIG. 1 is, in turn, depicted in FIG. 4, only in this embodiment a plasma emitter 73 is utilised as a non-contact cleaning element 7. FIG. 5 schematically shows a further embodiment according to the invention. In this case, the cleaning device 4 is configured as a cleaning unit and has a housing 41. In addition, the cleaning unit comprises a cleaning element 7 in the form of a laser 71 as well as an applicator 8 for applying cleaning agent 81 to the surface 311 of the film roller 31. In this exemplary embodiment, the cleaning unit is provided on a rail 9 so that the cleaning unit can be moved to the third film roller 31 for cleaning the latter. In this case, the rail 9 is only intended to depict the idea according to the invention, in sketch form, that the cleaning unit can be mobile in one embodiment and can be moved between the film rollers 31.

The embodiments shown here only represent examples of the present invention and thus should not be construed as limiting. Alternative embodiments considered by the person skilled in the art are equally comprised within the protective scope of the present invention.

### LIST OF REFERENCE NUMERALS

1 Film processing line
2 Film web
3 Roller device
31 Film roller
311 Surface
4 Cleaning device
41 Housing
5 Coating
7 Cleaning element
71 Laser
72 Vapour applicator
721 Vapour
73 Plasma emitter
8 Applicator
81 Cleaning agent
9 Rail
10 Measuring device
MD Machine direction

1-22. (canceled)

23. A film processing line for producing a plastic film web, comprising:
a machine direction (MD) along which the film web is transported via the film processing line and;
a roller device that processes or conducts the film material,
wherein the roller device is provided with at least one film roller that is in contact with the film web,
and wherein
the film processing line includes a cleaning device, with which a surface of the at least one film roller of the roller device in contact with the film web cleaned in an operating state.

24. The film processing line according to claim 23, wherein the cleaning device is configured to at least partially remove a coating on the surface of the film roller in contact with the film web.

25. The film processing line according to claim 24, wherein the film processing line has a measuring device which further comprises a camera configured to measure a thickness of the coating on the surface of the film roller in contact with the film web.

26. The film processing line according to claim 24, wherein the cleaning device is configured to deliver the coating at least partially to the film web.

27. The film processing line according to claim 24, wherein the cleaning device is provided with a cleaning element for non-contact removal of the coating.

28. The film processing line according to claim 24, wherein the cleaning device is provided with a cleaning element for abrasive removal of the coating.

29. The film processing line according to claim 27, wherein the cleaning element further comprises a laser which is configured to remove the coating.

30. The film processing line according to claim 29, wherein the laser is a pulse laser with a frequency in a range between 50 kHz and 300 kHz.

31. The film processing line according to claim 29, wherein the laser has a power between 2 W and 30 W.

32. The film processing line according to claim 29, wherein the laser has a wavelength between 400 and 1200 nm.

33. The film processing line according to claim 27, wherein the cleaning element further comprises a vapour applicator which is configured to remove the coating with a vapour.

34. The film processing line according to claim 33, wherein
the vapour is water vapour
or a solvent selected from the group of aprotic solvents, protic solvents and indifferent solvents.

35. The film processing line according to claim 27, wherein the cleaning element further comprises a plasma emitter configured to remove the coating.

36. The film processing line according to claim 24, wherein the cleaning device is provided with an applicator for cleaning agents for application to the surface and/or the coating on the surface of the at least one film roller in contact with the film web.

37. The film processing line according to claim 23, wherein
the cleaning device is configured as a cleaning unit which has a housing, and wherein
the cleaning unit forms a mobile unit which can be moved for cleaning the surfaces of a plurality of the film rollers of the roller device in contact with the film web.

38. A cleaning device for the film processing line according to claim 23.

39. A method for cleaning components of film processing lines for producing a film web, the method comprising steps of:
a. providing a film processing line,
b. providing a roller device that processes or conducts a film material which is provided with at least one film roller that is in contact with the film web,
c. providing a cleaning device, with which a surface of the at least one film roller of the roller device in contact with the film web can be cleaned in an operating state,
d. cleaning the at least one film roller of the roller device in contact with the film web in the operating state by at least partially removing a coating on the at least one film roller.

40. The method according to claim 39, further comprising the step of partially or completely recirculating the removed coating.

41. The method according to claim 39, wherein the cleaning is performed by a traversing movement or as all-over cleaning.

42. The method according to claim 39, further comprising the steps of:
a. providing a measuring device which comprises a camera, wherein the measuring device is configured to measure a thickness of the coating on the surface of the film roller in contact with the film web,
b. performing a measurement of the thickness of the coating on the film roller of the roller device that is in contact with the film web,
c. controlling the cleaning device as a function of the thickness measured of the coating.

43. The method according to claim 42, wherein the measurement of the thickness of the coating is performed by emitting light on the surface of the film roller and subsequently measuring a reflected proportion of the light, wherein the method further comprises the step of performing a grey-scale value analysis on a basis of the reflected proportion measured in order to determine the thickness of the coating.

44. The method according to claim 42, wherein a control system of the cleaning device provides at least one regulation, a triggering and/or a shutdown of cleaning of the surface of the film roller.
